(19) United States
(12) Patent Application Publication
(10) Pub. No.: US 2005/0195308 A1
(43) Pub. Date: Sep. 8, 2005

(54) Image pick-up system

(75) Inventor: Mamoru Miyashita, Saitama-ken (JP)

Correspondence Address: BIRCH STEWART KOLASCH & BIRCH, PO BOX 747, FALLS CHURCH, VA, 22040-0747, US

(73) Assignee: Fuji Photo Film Co., Ltd.

(21) Appl. No.: 10/989,495

(22) Filed: Nov. 17, 2004

(30) Foreign Application Priority Data
Mar. 2, 2004 (JP) 2004-57844
Jul. 27, 2004 (JP) 2004-218484

(51) Int. Cl. H04N 5/222

(52) U.S. Cl. 348/333.01

(57) ABSTRACT

An image pick-up system is structured so as to include a main body, a display section, a section which detects posture of the main body, and a display switching section. The display section performs through-image display, in which image data taken-in at a given frame rate is displayed continuously, and playback display of a still image after photographing. The detecting section detects whether or not the main body is at a posture within a range for confirming image playback. Display is switched by the display switching section such that, when the detecting section detects that the main body is at a posture within the confirmation range, a playback image is displayed at the display section, and when the detecting section detects that the main body is not at a posture within the confirmation range, through-images are displayed at the display section.

### CROSS-REFERENCE TO RELATED APPLICATION

This application claims priority under 35 USC §119 from Japanese Patent Application Nos. 2004-218484 and 2004-57844, the disclosure of which is incorporated by reference herein.

### BACKGROUND OF THE INVENTION

1. Technical Field

The present invention relates to an image pick-up system and device. In particular, the present invention relates to an image pick-up device having a display section which can carry out through image display, in which image data taken-in at predetermined frame rate is displayed continuously as a dynamic image, and playback display of a still image after photographing.

2. Description of the Related Art

Image pick-up devices which are currently on the market such as digital cameras and the like have a so-called post-view (REC-view) function which displays a still image, which has been photographed, on a display section immediately after photographing. The time over which the still image is displayed in post-view is usually 1 to 3 seconds, and there are image pick-up devices in which the user can freely set this time to be a longer time. If there are cases in which the user desires a longer post-view period, there may be cases in which a short post-view period will suffice. However, with the current technology, the post-view time period cannot be changed if the setting is not changed, which is inconvenient.

Japanese Patent Application Laid-Open (JP-A) No. 11-261891 discloses a technique in which the inclination of a camera is detected, and it is judged whether the camera is in a position of photographing vertically. If the camera is in a position of photographing vertically, display is carried out with the playback display converted from vertical to horizontal. However, this JP-A No. 11-261891 does not disclose switching between through image display and playback display of a still image after photographing.

### SUMMARY OF THE INVENTION

The present invention was developed in light of the aforementioned, and an object thereof is to provide an image pick-up device which can appropriately carry out switching between through image display and playback display of a still image after photographing.

In order to achieve the above object, an image pick-up device of a first aspect of the present invention is structured so as to include a display section, an angle change or direction detecting section, and a display switching section. The display section can carry out through image display, in which image data taken-in at a frame rate is displayed continuously, and playback display of a still image after photographing. The angle change or direction detecting section can detect an angle change of a threshold or greater of the display section, or whether or not the display section is oriented in a given direction. The display switching section switches display between the through image display and the playback display, when an angle change of the threshold or greater of the display section is detected by the angle change detecting section, or in accordance with whether or not the display section is oriented in the given direction.

In an image pick-up device, usually, through image display, in which image data taken-in at a frame rate is displayed continuously as a dynamic image, is carried out at the display section at the time of photographing, and playback display of a still image is carried out after that still image has been taken-in. The playback display of the still image is carried out during a fixed period of time after the still image has been taken-in, regardless of the wishes of the user.

The user aims the image pick-up lens toward a subject at the time of photographing the subject. When the user confirms the photographed image after photographing, he/she moves the display section of the image pick-up device to a position at which it is easy to view the display section. An angle change of a threshold or greater generally accompanies this movement of the display section.

Thus, in the above-described image pick-up device, when an angle change of a threshold or greater of the display section is detected by the angle change detecting section, switching of display between through image display and playback display is carried out by the first display switching section. In this way, due to the user changing the angle of the display section by a threshold or greater after photographing, the still image after photographing can be displayed at the display section. Then, due to the user changing the angle of the display section by the predetermined amount or more, the display of the still image ends and can be switched to through image display. Accordingly, the switching between through image display and playback display of a still image after photographing can be carried out appropriately in accordance with the simple operation of changing the inclination of the display section.

An image pick-up device of a second aspect of the present invention is structured so as to include: an image pick-up device main body; a display section able to carry out through image display, in which image data taken-in at a frame rate is displayed continuously, and playback display of a still image after photographing; a posture detecting section able to detect whether or not the image pick-up device main body is at a posture within a playback confirmation range; and a third display switching section which, when the posture detecting section detects that the image pick-up device main body is at a posture within the playback confirmation range, displays a playback image at the display section, and when the posture detecting section detects that the image pick-up device main body is not at a posture within the playback confirmation range, displays through images at the display section.

As described above, the user aims the image pick-up lens toward a subject at the time of photographing the subject. When the user confirms the photographed image after photographing, he/she moves the image pick-up device main body to a position at which it is easy to view the display section of the image pick-up device. A position at which it is easy for the user to view the display section is usually a position at which the image pick-up device main body is set at a posture within a predetermined range.

In the image pick-up device of the second aspect of the present invention, postures within the aforementioned predetermined range are considered to be within the playback confirmation range. The posture detecting section detects whether or not the image pick-up device main body is at a posture within the playback confirmation range. Then, if it is detected that the image pick-up device main body is at a posture within the playback confirmation range, the third display switching section displays the playback image at the display section. If it is detected that the image pick-up device main body is not at a posture within the playback confirmation range, the third display switching section displays through images at the display section. In this way, due to the user setting the image pick-up device main body at a posture within the playback confirmation range after photographing, the still image after photographing can be displayed at the display section. Due to the user setting the image pick-up device main body at a posture outside of the playback confirmation range, through image display can be carried out at the display section. Accordingly, the switching between the through image display and the playback display of a still image after photographing can be carried out appropriately in accordance with the posture of the image pick-up device main body.

### BRIEF DESCRIPTION OF THE DRAWINGS

FIG. 1A is a front view of a digital camera of a first embodiment.

FIG. 1B is a rear view of the digital camera of the first embodiment.

FIG. 2 is a schematic block diagram of a control system of the digital camera of the first embodiment.

FIG. 3 is a perspective view showing the inclination of an LCD of the first embodiment.

FIG. 4 is a flowchart of first image pick-up display switching processing.

FIG. 5 is a schematic block diagram of a control system of a digital camera of a second embodiment.

FIG. 6 is a schematic view of an upward sensing sensor.

FIG. 7 is a side view showing the direction of an LCD of the second embodiment.

FIG. 8 is a flowchart of second image pick-up display switching processing.

FIG. 9 is a flowchart of a modified example of the second image pick-up display switching processing.

FIG. 10 is a schematic block diagram of a control system of a digital camera of a third embodiment.

FIG. 11 is a flowchart of third image pick-up display switching processing.

FIG. 12 is a flowchart of a modified example of the third image pick-up display switching processing.

### DETAILED DESCRIPTION OF THE INVENTION

### First Embodiment

Hereinafter, a first embodiment of an image pick-up device of the present invention will be described with reference to the drawings. In the present embodiment, description will be given by using a digital camera as an example of the image pick-up device.

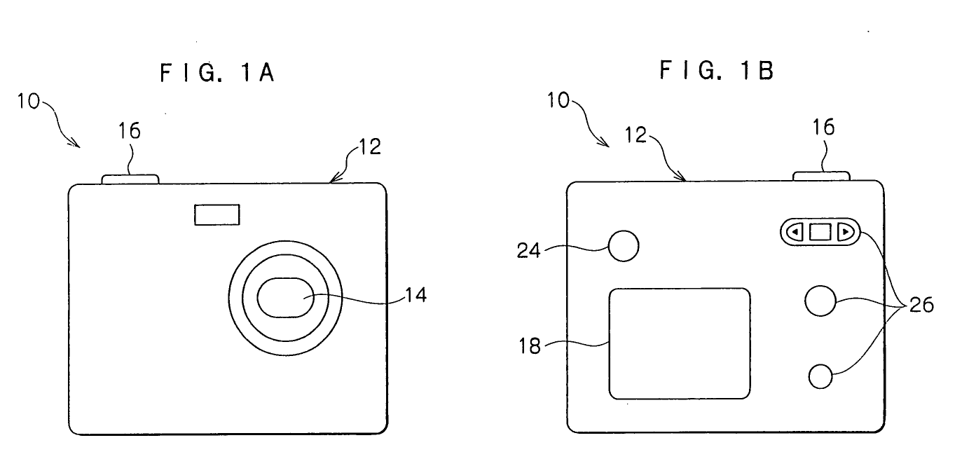

As shown in FIG. 1A, a digital camera 10 of the present embodiment has a housing 12. The digital camera 10 has a lens 14 at the front surface thereof, and a release button 16 at the top surface thereof. Further, as shown in FIG. 1B, the digital camera 10 has, at the reverse surface thereof, a liquid crystal display (hereinafter “LCD”) 18, a finder 20, a power source switch 24, and plural input keys 26 for carrying out other various types of input.

The LCD 18 can carry out through image display, in which image data taken-in into the digital camera 10 at predetermined frame rate is displayed continuously as a dynamic image, playback display (hereinafter, “post-view display”) in which a still image which has been photographed is displayed, display of images recorded in an external memory 60 which will be described later, display of various other types of menu screens, display of messages, and the like.

In the present embodiment, when the release button 16 is depressed, an AE (Automatic Exposure) function works to set the exposure state (the shutter speed, the state of the diaphragm). Thereafter, an AF (Auto Focus) function works to control the focus, and exposure (photographing) is carried out thereafter.

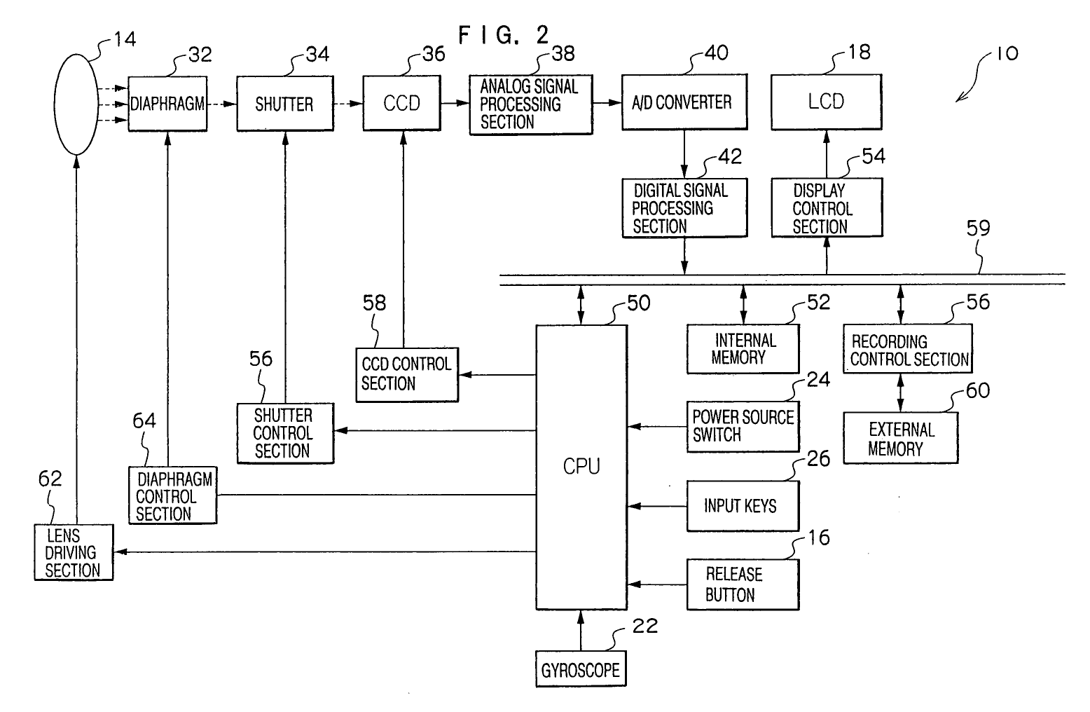

A schematic block diagram of the control system of the digital camera 10 is shown in FIG. 2. The digital camera 10 is provided with a diaphragm 32 which adjusts the amount of light passing through the lens 14, a shutter 34 which adjusts the time over which the light passes through, and a CCD 36 which photoelectrically converts the light and outputs an analog image signal.

The CCD 36 is connected to an analog signal processing section 38. The analog signal processing section 38 is connected to an analog/digital converter (hereinafter, “A/D converter”) 40. The A/D converter 40 is connected to a digital signal processing section 42. The analog signal processing section 38 carries out a predetermined analog signal processing on the signal inputted from the CCD 36. The A/D converter 40 converts the analog signal, which is inputted from the analog signal processing section 38, into a digital signal, and outputs the digital signal to the digital signal processing section 42. The digital signal processing section 42 carries out various types of processings on the inputted digital signal, and generates digital image data.

An internal memory 52, a display control section 54, a recording control section 56, and a compressing/decompressing section 58 are provided at the digital camera 10. The digital signal processing section 42, a CPU 50, the internal memory 52, the display control section 54, the recording control section 56, and the compressing/decompressing section 58 are connected to one another via a bus 59.

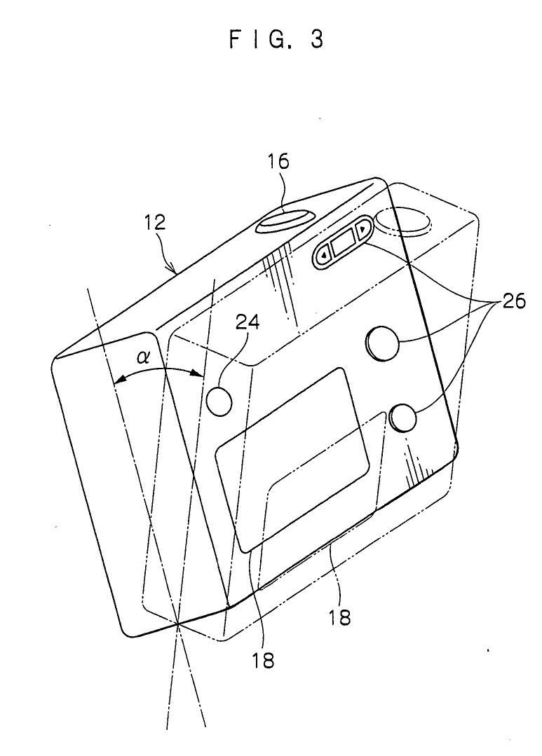

The CPU 50 carries out overall control of the digital camera 10, such as executing various programs and the like. The CPU 50 is connected to the power source switch 24, the input keys 26, and the release button 16, such that various types of instructions from these respective portions are inputted to the CPU 50. The CPU 50 is also connected to a gyroscope 22. As shown in FIG. 3, the gyroscope 22 can sense an angle change of whether or not an angle change of the LCD 18 in the vertical direction by a predetermined amount α° or more has arisen. If the gyroscope 22 senses an angle change of the predetermined amount α° or more, the gyroscope 22 outputs to the CPU 50 an angle change signal S1 expressing that an angle change has arisen.

Digital image data prepared at the digital signal processing section 42, various types of programs for controlling the digital camera 10, and the like are stored in the internal memory 52. The recording control section 56 can be connected to the external memory 60, and can carry out processing for writing digital image data to the external memory 60, and processing for reading digital image data from the external memory 60. The display control section 54 is connected to the LCD 18, and carries out predetermined processings for displaying images and the like on the LCD 18.

The digital camera 10 has a lens driving section 62 for driving the lens 14, a diaphragm driving section 64 for driving the diaphragm 32, a shutter driving section 56 for driving the shutter 34, and a CCD control section 68 for carrying out timing control of the CCD 36 at the time of photographing. The lens driving section 62, the diaphragm driving section 64, the shutter driving section 66, and the CCD control section 68 are connected to the CPU 50.

Next, operation of the present embodiment will be described.

When the user photographs a subject by using the digital camera 10, first, the user turns the power source on by using the power source switch 24. In this way, the power source of the digital camera 10 is turned on, an instruction to drive the lens is issued from the CPU 50 to the lens driving section 62, and the lens 14 is projected outwardly of the housing 12.

A CCD control instruction is issued from the CPU 50 to the CCD control section 58. The CCD 36 receives light from the subject at a predetermined timing, photoelectrically converts the light, and outputs to the analog signal processing section 38 the analog signal obtained by the photoelectric conversion. The analog signal processing section 38 carries out predetermined processings such as noise removal and the like, and outputs the processed signal to the A/D converter 40. At the A/D converter 40, the analog signal is converted into a digital signal, and the digital signal is outputted to the digital signal processing section 42. At the digital signal processing section 42, predetermined processings are carried out on the inputted digital signal, and digital image data is prepared. The above-described processings from the CCD control instruction to the preparation of the digital image data correspond to the “taking-in of the image” of the present invention. The digital image data obtained by the taking-in of the image is stored in the internal memory 52, and also is outputted to the display control section 54 where it is subjected to predetermined processings by the display control section 54. Images based on the digital image data are thereby continuously displayed on the LCD 18 as a dynamic image at a predetermined frame rate.

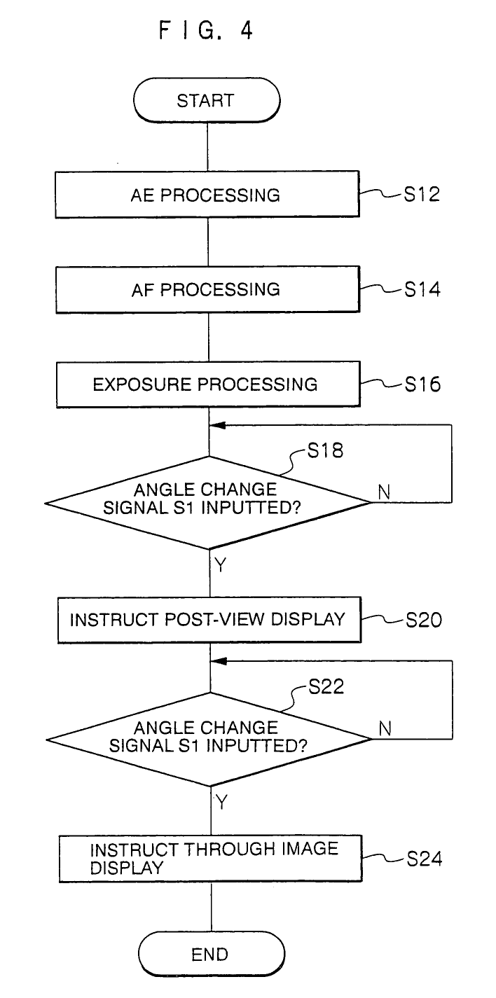

Then, when the release button is depressed, the first image pick-up display switching processing shown in FIG. 4 is executed at the CPU 50. First, in step S12, AE processing is carried out, and in step S14, AF processing is carried out. Then, in step S16, exposure processing is carried out and a still image is taken-in. At this time, through images are displayed on the LCD 18. In step S18, processing stands by until the angle change signal S1 is inputted from the gyroscope 22. If the user wishes to confirm the still image, the user changes the angle of the LCD 18 in the vertical direction by a predetermined amount (threshold) or more. The angle change signal S1 is inputted to the CPU 50 from the gyroscope 22 due to the angle change, of a predetermined amount or more in the vertical direction, of the LCD 18. When the angle change signal S1 is inputted, in step S20, an instruction to switch the display to post-view display is outputted to the display control section 54. In this way, the still image which has been taken-in is displayed on the LCD 18. The user can thereby confirm the still image. In step S22, processing stands-by until the angle change signal S1 is again inputted from the gyroscope 22. If the user wishes to continue confirming the still image, he/she maintains the vertical direction angle of the LCD 18 as is, whereas if the user wishes to end this confirming, he/she changes the vertical direction angle of the LCD 18 by the predetermined amount or more. The angle change signal S1 is outputted from the gyroscope 22 to the CPU 50 due to this change in the angle of the LCD 18 in the vertical direction by the predetermined amount or more. When the angle change signal S1 is inputted, in step S24, an instruction to switch the display to through image display is outputted to the display control section 54. Through images are thereby displayed on the LCD 18.

In accordance with the present embodiment, the switching between through image display and post-view display is carried out by detecting a change, of a predetermined amount of more, in the angle of the LCD 18. Thus, if the user maintains the angle of the LCD 18, the current display (through image display or post-view display) can be maintained. If the user changes the angle of the LCD 18 by the predetermined amount or more, the through image display can be switched to post-view display, or the post-view display can be switched to through image display.

### Second Embodiment

Next, a second embodiment of the image pick-up device of the present invention will be described. In the present embodiment, portions which are similar to those of the first embodiment are denoted by the same reference numerals, and detailed description thereof is omitted.

The outer shape of a digital camera 70 of the present embodiment is similar to that of the digital camera 10 of the first embodiment (see FIG. 1).

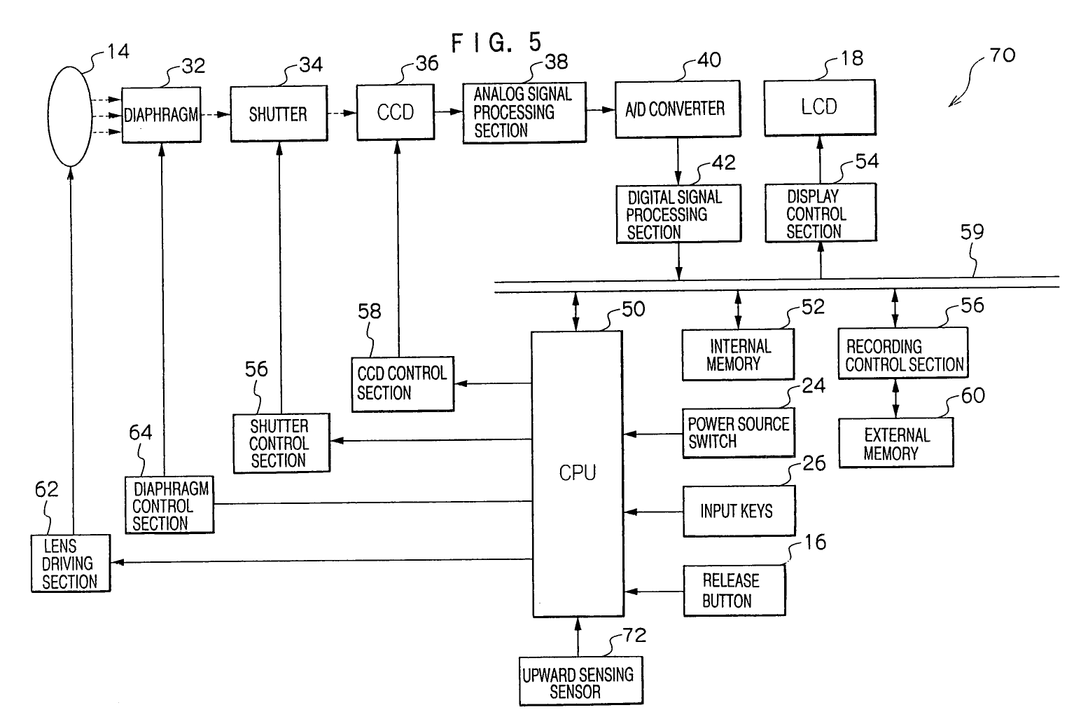

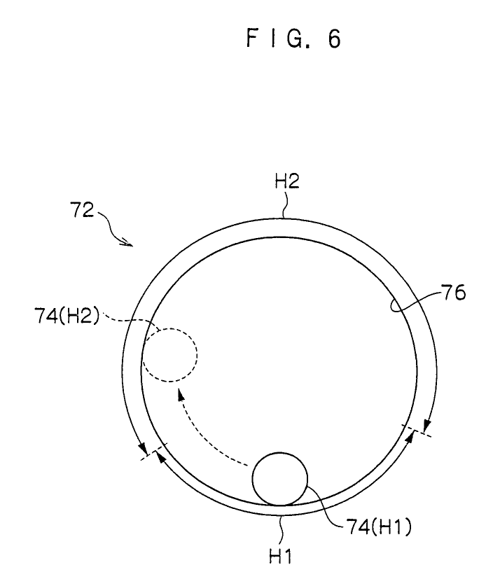

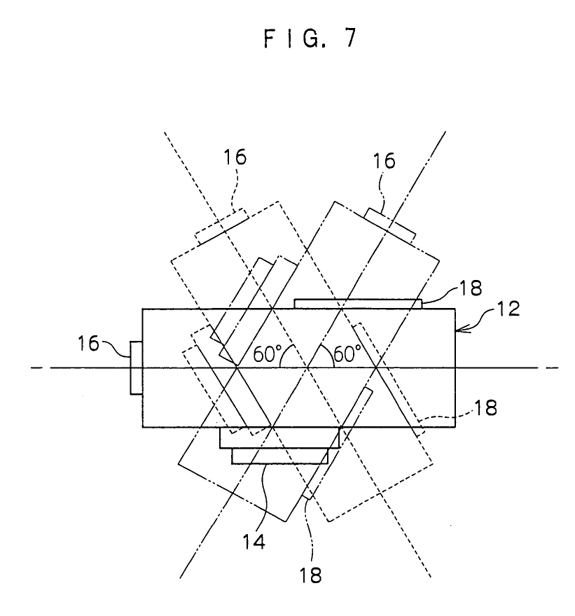

FIG. 5 is a schematic block diagram of the control system of the digital camera 70. The digital camera 70 has a upward detecting sensor 72, instead of the gyroscope 22 of the first embodiment. As shown in FIG. 6, the upward detecting sensor 72 has a weight 74 and a weight receiving wall 76. Further, as shown in FIG. 7, if the LCD 18 is within a range of 60° from the horizontal direction, the weight 74 abuts the weight receiving wall 76 within an upward range H1 (see FIG. 6), and a post-view display request signal S2 is outputted to the CPU 50. Further, if the LCD 18 is positioned outside of the range of 60° from the horizontal direction, the weight 74 abuts the weight receiving wall 76 at a range H2 which is other than the upward range (see FIG. 6), and a through image display request signal S3 is outputted to the CPU 50.

As other structures are similar to those of the first embodiment, detailed description thereof will be omitted.

Next, operation of the present embodiment will be described.

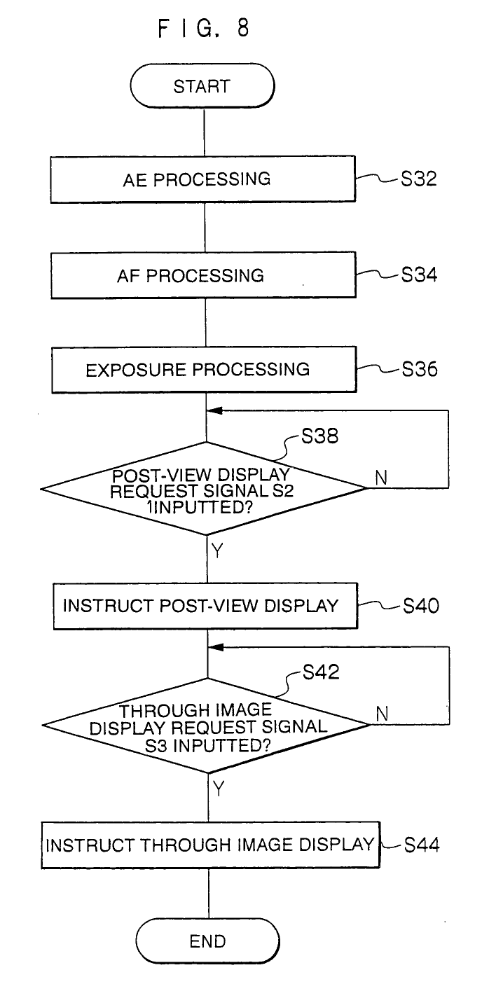

Operations from the user turning the power source on to the taking-in of the dynamic image are similar to those in the first embodiment. In the second embodiment, when the release button 16 is depressed, the CPU 50 executes the second image pick-up display switching processing shown in FIG. 8. First, in step S32, AE processing is carried out, and in step S34, AF processing is carried out. Then, in step S36, exposure processing is carried out and a still image is taken-in. At this time, through images are displayed on the LCD 18. In step S38, processing stands by until the post-view display request signal S2 is inputted from the upward detecting sensor 72. If the user wishes to confirm the still image, the user orients the LCD 18 within a range of 60° with respect to the horizontal direction. When the LCD 18 is oriented within a range of 60° from the horizontal direction, the post-view display request signal S2 is outputted from the upward detecting sensor 72 to the CPU 50. When the post-view display request signal S2 is inputted, in step S40, an instruction to switch display to post-view display is outputted to the display control section 54. In this way, the still image which has been taken-in is displayed on the LCD 18. The user can confirm the still image here. In step S42, processing stands-by until the through image display request signal S3 is inputted from the upward detecting sensor 72. If the user wishes to continue confirming the still image, he/she maintains the direction of the LCD 18 as is, whereas if the user wishes to end this confirming, he/she orients the direction of the LCD 18 to outside of the range of 60° from the horizontal direction. When the direction of the LCD 18 is oriented outside of the range of 60° from the horizontal direction, the through image display request signal S3 is outputted from the upward detecting sensor 72 to the CPU 50. When the through image display request signal S3 is inputted, in step S44, an instruction to switch the display to through image display is outputted to the display control section 54. In this way, through images are displayed on the LCD 18.

In accordance with the present embodiment, the switching between through image display and post-view display is carried out in accordance with the orientation of the LCD 18. Therefore, the user can display the desired display in accordance with the orientation of the LCD 18.

In the present embodiment, description is given of an example in which the post-view display request signal S2 is outputted within the range of 60° from the horizontal direction, and the through image display request signal S3 is outputted outside of the range of 60° from the horizontal direction. However, the switching of the output of the post-view display request signal S2 and the through image display request signal S3 does not have to be within/outside of the range of 60° from the horizontal direction, and can be made to be a direction which is within/outside of an arbitrary range.

Further, in the second image pick-up display switching processing of the present embodiment, in step S42, the routine stands-by until the through image display request signal S3 is inputted. However, display can be automatically switched to the through image display if, during a predetermined time period after post-view display, there is no input of either the post-view display request signal S2 or the through image request signal S3.

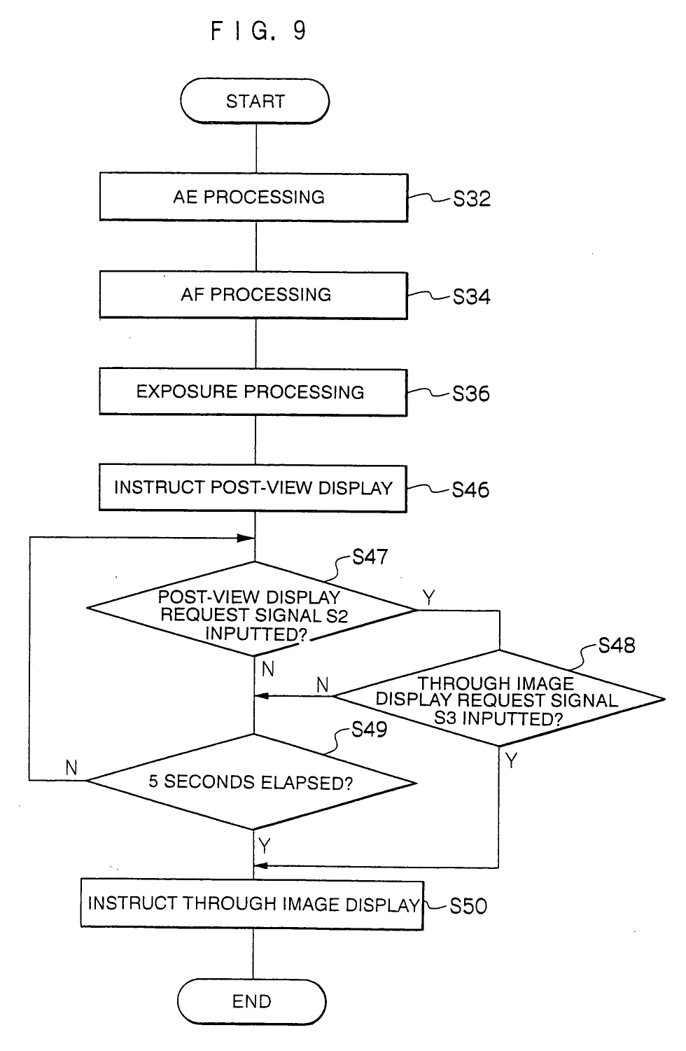

In this case, as shown in FIG. 9, after the exposure processing of step S36, a post-view display instruction is outputted in step S46. Then, in step S47, it is judged whether or not the post-view display request signal S2 has been inputted. If the judgment is affirmative, the routine moves on to step S48. If the judgment in step S47 is affirmative, in step S48, it is judged whether or not the through image request signal S3 has been inputted. If the judgment in step S48 is negative, the routine proceeds to step S49, and when the judgment is affirmative, the routine proceeds to step S50. In step S49, it is judged whether or not a predetermined time period, e.g., 5 seconds, has elapsed after the post-view display. If the predetermined time period has elapsed, the routine moves on to step S50. In step S50, a through image display instruction is outputted. If the judgment in step S49 is negative, i.e., if 5 seconds has not elapsed after the post-view display, the routine returns to step S47.

In accordance with the present processing, if there is no input of the post-view display request signal S2 or the through image request signal S3 during a predetermined time period after post-view display, the display is automatically switched to through image display.

Note that, in the present embodiment, 5 seconds is given as an example of the predetermined time period. However, a time period of less than 5 seconds (1 to 4 seconds), or a time period of longer than 5 seconds may be used.

### Third Embodiment

Next, a third embodiment of the image pick-up device of the present invention will be described. In the present embodiment, portions which are similar to those of the first and second embodiments are denoted by the same reference numerals, and detailed description thereof is omitted.

The outer shape of a digital camera 80 of the present embodiment is similar to that of the digital camera 10 of the first embodiment (see FIG. 1).

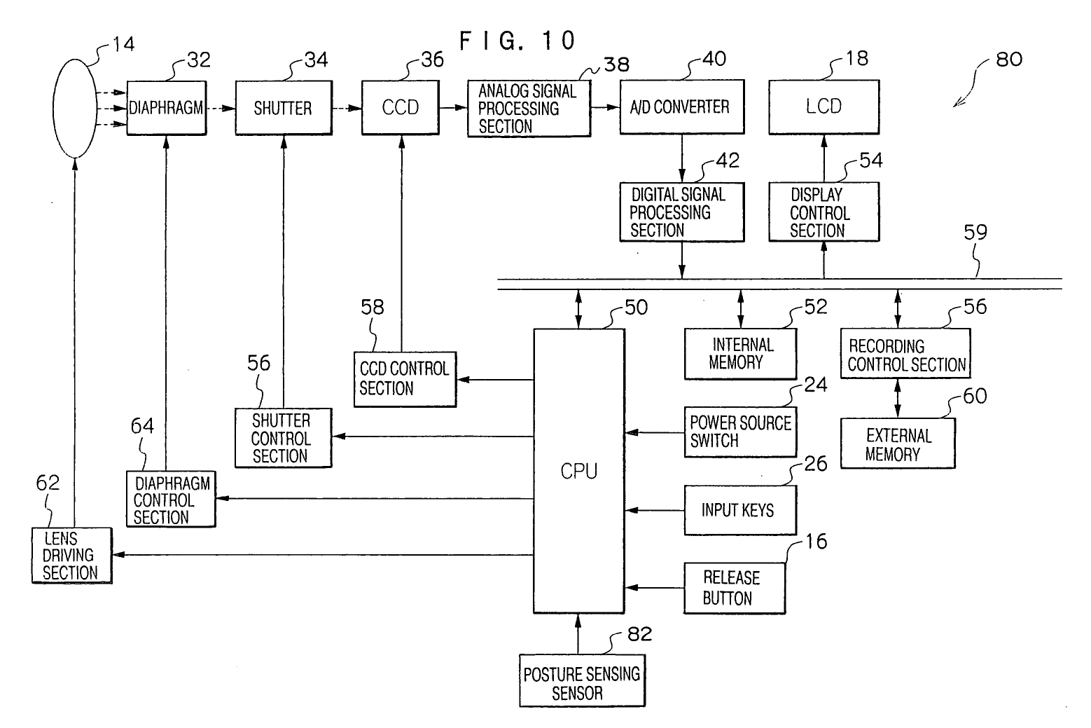

FIG. 10 is a schematic block diagram of the control system of the digital camera 80. The digital camera 80 has a posture detecting sensor 82 instead of the upward detecting sensor 72 of the second embodiment. The posture detecting sensor 82 can sense the posture of the housing 12 which serves as the image pick-up device main body. If the LCD 18 is at an angle within a range of 60° from the horizontal direction, the posture of the housing 12 is considered to be a post-view confirming posture, and a post-view confirmation signal S4 is outputted to the CPU 50. If the angle of the LCD 18 is outside of the range of 60° from the horizontal direction, the posture of the housing 12 is considered to be a through image confirming posture, and a through image confirmation signal S5 is outputted to the CPU 50.

As other structures are similar to those of the first and second embodiments, detailed description thereof will be omitted.

Next, operation of the present embodiment will be described.

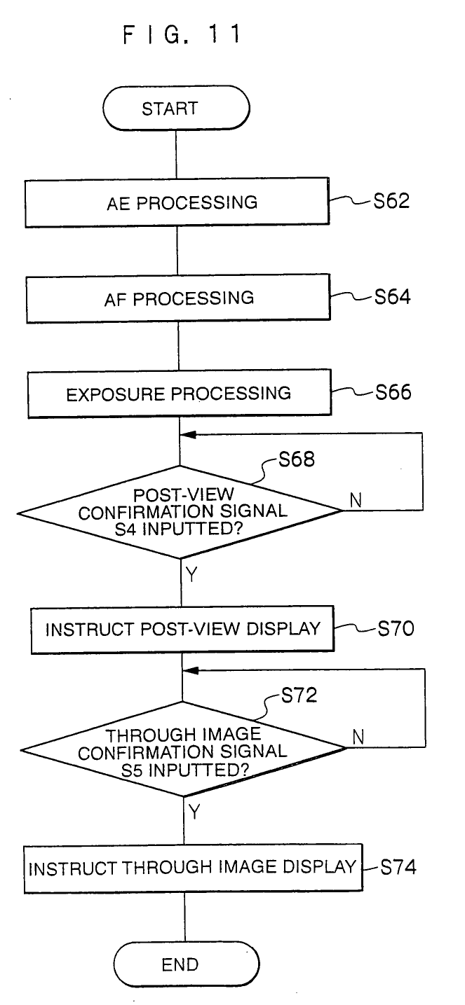

Operations from the user turning the power source on to the taking-in of the dynamic image are similar to those in the first embodiment. In the third embodiment, when the release button 16 is depressed, the CPU 50 executes the third image pick-up display switching processing shown in FIG. 11. First, in step S62, AE processing is carried out, and in step S64, AF processing is carried out. Then, in step S66, exposure processing is carried out and a still image is taken-in. At this time, through images are displayed on the LCD 18. In step S68, processing stands by until the post-view confirmation signal S4 is inputted from the posture detecting sensor 82. If the user wishes to confirm the still image, the user sets the LCD 18 at an angle within a range of 60° from the horizontal direction, i.e., sets the housing 12 at a post-view confirming posture. When the LCD 18 is set at an angle within a range of 60° from the horizontal direction, the post-view confirmation signal S4 is outputted from the posture detecting sensor 82 to the CPU 50. When the post-view confirmation signal S4 is inputted, in step S70, an instruction to switch display to post-view display is outputted to the display control section 54. In this way, the still image which has been taken-in is displayed on the LCD 18. The user can confirm the still image here. In step S72, processing stands-by until the through image confirmation signal S5 is further inputted from the posture detecting sensor 82. If the user wishes to continue confirming the still image, he/she maintains the posture of the housing 12 as is, whereas if the user wishes to end this confirming, he/she moves the housing 12 so as to set the angle of the LCD 18 to outside of the range of 60° from the horizontal direction, i.e., so as to set the housing 12 at a through image confirming posture. When the angle of the LCD 18 is outside of the range of 60° from the horizontal direction, the through image confirmation signal S5 is outputted from the posture detecting sensor 82 to the CPU 50. When the through image confirmation signal S5 is inputted, in step S74, an instruction to switch the display to through image display is outputted to the display control section 54. In this way, through images are displayed on the LCD 18.

In accordance with the present embodiment, the switching between through image display and post-view display is carried out in accordance with the posture of the housing 12. Therefore, the user can display the desired display by changing the posture of the housing 12.

In the present embodiment, description is given of an example in which the post-view confirmation signal S4 is outputted when the angle of the LCD 18 is within the range of 60° from the horizontal direction, and the through image confirmation signal S5 is outputted when the angle of the LCD 18 is outside of the range of 60° from the horizontal direction. However, the switching of the output of the post-view confirmation signal S4 and the through image confirmation signal S5 does not have to be within/outside of the range of 60° from the horizontal direction, and can be made to be an angle which is within/outside of an arbitrary range.

Further, in the third image pick-up display switching processing of the present embodiment, in step S72, the routine stands-by until the through image confirmation signal S5 is inputted. However, display can be automatically switched to the through image display if, during a predetermined time period after post-view display, there is no input of either the post-view confirmation signal S4 or the through image confirmation signal S5.

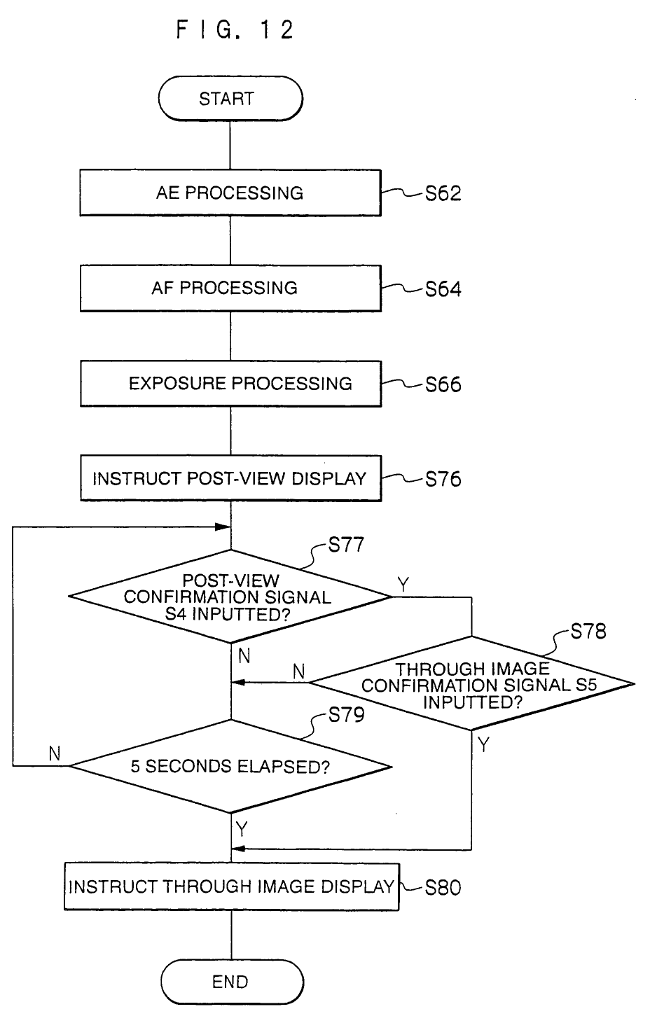

In this case, as shown in FIG. 12, after the exposure processing of step S66, a post-view display instruction is outputted in step S76. Then, in step S77, it is judged whether or not the post-view confirmation signal S4 has been inputted. If the judgment is affirmative, the routine moves on to step S78. If the judgment is negative, the routine proceeds to step S79. In step 78, it is judged whether or not the through image confirmation signal S5 has been inputted. If the judgment is affirmative, the routine proceeds to step S80, whereas if the judgment is negative, the routine proceeds to step S79. In step S79, it is judged whether or not a predetermined time period, e.g., 5 seconds, has elapsed after the post-view display. If the predetermined time period has elapsed, the routine moves on to step S80. In step S80, a through image display instruction is outputted. If the judgment in step S79 is negative, i.e., if 5 seconds has not elapsed after the post-view display, the routine returns to step S77.

In accordance with the present processing, if there is no input of the post-view confirmation signal S4 or the through image confirmation signal S5 during a predetermined time period after post-view display, the display is automatically switched to through image display.

Note that, in the present embodiment, 5 seconds is given as an example of the predetermined time period. However, a time period of less than 5 seconds (1 to 4 seconds), or a time period of longer than 5 seconds may be used.

In the above-described first, second and third embodiments, the digital camera is described as an example of the image pick-up device. However, other than digital cameras, the present invention may be applied to all types of image pick-up devices such as cell phones with cameras, digital video cameras, and the like.

The image pick-up device of the present invention may be structured so as to include a time-based switching section. This time-based switching section is a section which carries out the function of switching the display at the display section from playback display to through image display, when the angle change is not detected by the angle detecting section during a predetermined period of time after playback display is carried out at the display section.

If the angle change is not detected by the angle detecting section during the predetermined time period, the time-based switching section switches the display of the display section from playback display to through image display. In this way, display is automatically switched to through images even if there is not an angle change of a predetermined amount or more at the display section.

Instead of the angle detecting section, the image pick-up device of the present invention may have a direction detecting section which can detect whether or not the display section is oriented in a direction within a playback display request range, and a display switching section corresponding to the operation of this direction detecting section. When the direction detecting section detects that the display section is oriented in a direction within the playback display request range, the display switching section displays the playback image on the display section. When the direction detecting section detects that the display section is not oriented in a direction within the playback display request range, the display switching section displays through images on the display section.

As described above, the user directs the image pick-up lens toward the subject at the time of photographing the subject, and when the user confirms the photographed image after photographing, he/she moves the display section of the image pick-up device to a position at which it is easy to view the display section. Usually, the position at which it is easy for the user to view the display section is a position at which the display section is oriented in a direction which is within a given range.

Thus, at the image pick-up device, directions within the aforementioned given range may be considered as being within the playback image request range, and the direction detecting section may detect whether or not the display section is oriented in a direction within this playback image request range. If it is detected that the display section is oriented in a direction within the playback display request range, the display switching section displays the playback image on the display section. If it is detected that the display section is not oriented in a direction within the playback display request range, the display switching section displays through images on the display section. In this way, due to the user orienting the display section within the playback display request range after photographing, the photographed still image can be displayed at the display section. Due to the user orienting the display section to outside of the playback display request range, through image display can be carried out at the display section. Accordingly, the switching between through image display and playback display of a still image after photographing can be carried out appropriately in accordance with the direction in which the user orients the display section.

In the image pick-up device, the direction within the playback display request range may be a direction such that the display section is at an angle which is less than or equal to 60° from the horizontal direction.

When the user confirms the playback display of a still image at the display section, it is often the case that the display section is set at an angle which is less than or equal to 60° from the horizontal direction. Thus, in the above-described image pick-up device, it is detected whether or not the display section is oriented in a direction of an angle which is less than or equal to 60° from the horizontal direction. If it is detected that the display section is oriented in such a direction, the playback image is displayed on the display section. If it is detected that the display section is not oriented in such a direction, through images are displayed on the display section. In this way, due to the user orienting the display section at an angle of 60° or less from the horizontal direction after photographing, the still image after photographing can be displayed on the display section. Due to the user orienting the display section at an angle of greater than 60° from the horizontal direction, through image display can be carried out at the display section.

The image pick-up device may be structured so as to also include a time-based switching section which switches display at the display section from playback display to through image display, when a direction within the playback display request range is not detected by the direction detecting section at or after a predetermined time after playback display is carried out at the display section.

If a direction within the playback display request range is not detected by the direction detecting section during a predetermined time period, the time-based switching section switches the display at the display section from playback display to through image display. In this way, the display is automatically switched to through image display even if the display section is not oriented in a direction within the playback display request range.

The image pick-up device being at a posture such that the display section is at an angle of 60° or less from the horizontal direction, may be used for the direction within a playback confirmation range.

When the user confirms the playback display of a still image at the display section, it is often the case that he/she sets the display section at an angle of 60° or less from the horizontal direction. Thus, in the above-described image pick-up device, it is detected whether or not the display section provided at the image pick-up device main body is set at an angle of less than or equal to 60° from the horizontal direction. If it is detected that the display section is at such an angle, the playback image is displayed at the display section, whereas if it is detected that the display section is not at such an angle, through images are displayed at the display section. In this way, due to the user setting the display section at an angle of 60° or less from the horizontal direction after photographing, the still image after photographing can be displayed at the display section. Due to the user setting the display section at an angle of greater than 60° from the horizontal direction, through image display can be carried out at the display section.

The image pick-up device may be structured so as to also include a time-based switching section which switches display at the display section from playback display to through image display, if a posture within the playback confirmation range is not detected by the posture detecting section at or after a predetermined time after playback display is carried out at the display section.

If a posture within the playback confirmation range is not detected by the posture detecting section during a predetermined time period, the time-based switching section switches the display at the display section from playback display to through image display. In this way, the display is automatically switched to through image display even if the image pick-up device main body is not at a posture within the playback confirmation range.

As described above, in accordance with the image pick-up device of the present invention, switching between through image display and playback display of a still image after photographing can be carried out appropriately.

1. An image pick-up device comprising:
a display section able to carry out through image display, in which image data taken-in at a frame rate is displayed continuously, and playback display of a still image after photographing;
an angle change detecting section able to detect an angle change of a threshold or greater of the display section; and
a display switching section switching display between the through image display and the playback display, when an angle change of the threshold or greater of the display section is detected by the angle change detecting section.

2. The image pick-up device of claim 1, further comprising a time-based switching section switching display at the display section from the playback display to the through image display, when the angle change is not detected by the angle change detecting section during a threshold time period after the playback display is carried out at the display section.

3. The image pick-up device of claim 1, wherein the angle change detecting section has a gyroscope connected so as to be able to transmit signals to the display switching section.

4. An image pick-up device comprising:
a display section able to carry out through image display, in which image data taken-in at a frame rate is displayed continuously, and playback display of a still image after photographing;
a direction detecting section able to detect whether or not the display section is oriented in a direction within a playback display request range; and
a display switching section which, when the direction detecting section detects that the display section is oriented in a direction within the playback display request range, displays a playback image at the display section, and when the direction detecting section detects that the display section is not oriented in a direction within the playback display request range, displays through images at the display section.

5. The image pick-up device of claim 4, wherein the direction within the playback display request range is a direction in which the display section is set at an angle of 60° or less from a horizontal direction.

6. The image pick-up device of claim 4, further comprising a time-based switching section switching display at the display section from the playback display to the through image display, when a direction within the playback display request range is not detected by the direction detecting section at or after a threshold time after the playback display is carried out at the display section.

7. The image pick-up device of claim 4, wherein the direction detecting section has a sensor connected so as to be able to transmit signals to the display switching section.

8. An image pick-up system comprising:
an image pick-up device main body;
a display section provided at the image pick-up device main body, and able to carry out through image display, in which image data taken-in at a frame rate is displayed continuously, and playback display of a still image after photographing;
a posture detecting section able to detect whether or not the image pick-up device main body is at a posture within a playback confirmation range; and
a display switching section which, when the posture detecting section detects that the image pick-up device main body is at a posture within the playback confirmation range, displays a playback image at the display section, and when the posture detecting section detects that the image pick-up device main body is not at a posture within the playback confirmation range, displays through images at the display section.

9. The image pick-up system of claim 8, wherein the posture within the playback confirmation range is a posture at which the display section is set at an angle of 60° or less from a horizontal direction.

10. The image pick-up system of claim 8, further comprising a time-based switching section switching display at the display section from the playback display to the through image display, when a posture within the playback confirmation range is not detected by the posture detecting section at or after a threshold time after the playback display is carried out at the display section.

11. An image pick-up device comprising:
a display section able to carry out through image display, in which image data taken-in at a frame rate is displayed continuously, and playback display of a still image after photographing;
angle change detecting means for detecting an angle change of a threshold or greater of the display section; and
display switching means for switching display between the through image display and the playback display, when an angle change of the threshold or greater of the display section is detected by the angle change detecting means.

12. An image pick-up device comprising:
an image pick-up device main body;
a display section provided at the image pick-up device main body, and able to carry out through image display, in which image data taken-in at a frame rate is displayed continuously, and playback display of a still image after photographing;
posture detecting means for detecting whether or not the image pick-up device main body is at a posture within a playback confirmation range; and
display switching means for, when the posture detecting means detects that image pick-up device main body is at a posture within the playback confirmation range, displaying a playback image at the display section, and when the posture detecting means detects that the image pick-up device main body is not at a posture within the playback confirmation range, displaying through images at the display section.

13. A method of switching images in an image pick-up system, comprising:
displaying a first image when an image is taken-in;
making the image pick-up system stand-by until generation of a signal;
when a change in orientation of a portion of the image pick-up system arises, sensing the change and generating the corresponding signal; and
switching the first image to a second image in accordance with the signal.
